(19) United States
(12) Patent Application Publication
(10) Pub. No.: US 2021/0252998 A1
(43) Pub. Date: Aug. 19, 2021

(54) SEAT DEPTH ADJUSTMENT FOR A MOTOR VEHICLE SEAT THAT CAN BE ADJUSTED IN THE SEAT DEPTH THEREOF MANUALLY OR BY MOTOR

(71) Applicant: FISHER DYNAMICS GERMANY GMBH, Wuppertal (DE)

(72) Inventor: Hans Burckhard BECKER, Solingen Nordrhein-Westfalen (DE)

(21) Appl. No.: 16/980,940

(22) PCT Filed: Mar. 12, 2019
(86) PCT No.: PCT/EP2019/056124

§ 371 Date: Sep. 15, 2020

(30) Foreign Application Priority Data
Mar. 16, 2018 (DE) 10 2018 106 173.0

(51) Int. Cl. B60N 2/02

(52) U.S. Cl. CPC B60N 2/0232; B60N 2002/024

(57) ABSTRACT

A seat depth adjustment device for a vehicle seat that can be adjusted in the seat depth thereof electrically by an electric motor or manually by an operating lever includes a single-piece support plate made of plastic. The support plate includes (a) a support part, which extends in the sliding direction, (b) a front apron, (c) two guides, which extend parallel to each other in the sliding direction and are arranged at a distance from each other and are formed in the support part, and (d) a slot for a detent spring, which slot is formed in the support part and extends perpendicularly to the sliding direction. The devices further includes (e) a space for accommodating at least a part of the operating lever or of the electric motor and for the fastening thereof, which space is open downward and is delimited by the support part and the front apron.

### TECHNICAL FIELD

The disclosure relates to a seat depth adjustment of a motor vehicle seat, which has a seating area, which is connected to a base plate of the seat depth adjustment, and with a support plate, which can be adjusted with relation to the base plate in a sliding direction in different positions, wherein the support plate forms the leading edge of the seating area.

### BACKGROUND

In the previously known adjustment device according to DE 198 26 823 C1, an electric motor drives toothed gears that are mounted directly on the support plate. This can be adjusted with relation to a seat frame in which it is guided on the side.

In the motor vehicle seat previously known from DE 196 28 381 A1, a support plate is inserted into a U-shaped recess of the seat part that is open toward the front. The longitudinal guide is formed by a pipe and a sliding sleeve. A regulation between the support plate and the seat part is achieved by a winding spring and is carried out by operating manually.

A vehicle seat with an adjustable seat depth is known from DE 698 27 303 T2, in which a front seat part is adjusted relative to a rear seat part by means of an electric motor. In the case of the vehicle seat known from DE 199 13 503 A1, the seating area also has a front section and a rear section, which can be positioned at different distances by means of a manually operated adjustment device so that the seat depth can be adjusted.

A disadvantage of the previously known adjustment device of this type is that they are only intended for a manual or motorized embodiment. If both a manual as well as a motorized design is desired, the constructions are significantly different and the proportion of identical parts for both embodiments is very low. In light of the disclosure, this is seen as a disadvantage. It aims to use as many identical parts as possible for both embodiments.

### SUMMARY

Accordingly, the disclosure avoids the disadvantages of the previously known adjusting devices and to specify a seat depth adjustment device that uses as many identical parts as possible for both embodiments, thereby offering the possibility of converting the one embodiment into the other embodiment, even later on.

This task is achieved by means of a seat depth adjustment device for a vehicle seat, which can be adjusted in its seat depth in an adjustment direction by means of an electric motor or for a vehicle seat that can be manually adjusted by means of an operating lever
with a single-piece support plate made of plastic, which comprises (a) a support part, which extends in the sliding direction, (b) a front apron, which extends perpendicularly to the sliding direction and points downward from a leading edge of the support part, (c) two guides, which extend parallel to each other in the sliding direction and arranged at a distance from one another (d) a slot, which is formed in the support part and extends perpendicularly to the sliding direction, and (e) a space for the accommodation of at least a part of the operating lever or of the electric motor and for the fastening thereof, which space is open downward and delimited by the support part and by the front apron, and
with a single-piece metal base plate, which comprises guide means matched to the guides, detent recesses and fasteners arranged one following the other in the sliding direction.

In the case of this adjustment device, both the support plate and the base plate are used identically for both embodiments, thereby being suitable for both embodiments and being prepared accordingly. This leads to one feature or the other not being required for an embodiment, for example, the slot not being required for the motorized embodiment. However, it is always the case that the non-required feature in the other embodiment does not create any type of disruption.

In the assembled state, the two guides of the support plate engage into the guide means of the base plate. Thus, a relative movement between the support plate and the base plate is achieved and determined only in the sliding direction. The sliding path in the sliding direction is respectively delimited in both directions by a stop. Thus, the sliding path forward is delimited by the front apron of the support plate coming to rest against the front guides of the base plate.

The detent recesses of the guide means are preferably open upward. They are only used for the manual embodiment. Preferably, the guide means of the base plate protrude upward against a middle region of the base plate. This results in a free space between the support plate and the base plate, which is only accessible in the sliding direction. On the side, it is delimited by the engaged guide means and guides. The free space is used for the accommodation of at least one section of the operating lever or a spindle of a motor drive. This has a motorized rotary spindle and a spindle nut engaged with this; the latter is held on the base plate.

Preferably, the guides in the sliding direction push forward against the front apron, in particular, they are connected to this at the front. Delimiting of the sliding path forward is achieved by means of this. Preferably, two bearing regions for the pivot axis of the operating lever are provided on the underside of the support part. They each accommodate an end region of the pivot axis. In this case, it is advantageous if each bearing region is formed by a recess and a spring-loaded tongue located in its opening. When the end regions of the pivot axis are pressed into the recess, the tongues spring to the side until the end regions are in the recess and the tongues block the access to the recess again so that the return path is blocked.

Preferably, the guide means in the sliding direction are shorter than the guides; in particular, they are at least 30% shorter. Preferably, independently of the adjustment position of the support plate with relation to the base plate, the guide means are completely within the guide by at least over 80% of their length, preferably at least over 90% of their length. Supporting the support plate across the entire length of the guide means is achieved by means of this.

Preferably, at its front end, the base plate has an inlet located between the guide means. This inlet offers space for either the electric motor or the operating lever.

Preferably, the support plate has two supports arranged in the slot, which are each between the longitudinal centre of the slot and an end region of the detent spring. The detent spring rests on these supports. When the middle region of the detent spring is pushed downward by means of the operating lever; the free ends of the detent springs move upward. These free ends are usually engaged with detent recesses, which are formed in the base plate and are open upward. When the free ends are moved upward, they come out of the detent recesses. It is then possible to adjust the seat depth.

Preferably, the slot has a pocket located in the middle between the guides, which is an indentation of the slot. This indentation is directed toward the back. The pocket preferably takes up a nib of the operating lever, which moves up and down when actuating the operating lever within the pocket. Normally, the operating lever abuts a stop of the support part under the effect of the detent spring. The detent spring is thus used for a plurality of tasks. It is used for adjustment in the sliding direction by engaging into the detent recesses. Engagement is automatically; when sliding, the ends of the detent spring slide over the guide means and automatically engage into a detent recess, as long as this is not prevented by the operating lever.

Preferably, the operating lever comprises a U-shaped region with a front limb located in front of the front apron, with a base located below the front apron, and with a rear limb located behind the front apron. The operating lever is thus shaped in such a way that it supports the front apron; in other words, the lower one is guided around the front apron. Its front limb is in front of the front apron. Preferably, the operating lever furthermore has a flange adjoining the upper end of the rear limb, which is located in the space between the support plate and the base part. This flange supports the pivot axis of the operating lever. Two end regions of the pivot axis protrude away from the flange on side. These end regions or stumps are located in one of the bearing regions. The nib of the flange runs parallel to the sliding direction and extends into the pocket of the slot. It reaches through a middle region of the detent spring, thereby taking the centre of the detent spring with it during operating lever movements. Specifically, it pushes them downward when the front limb is pulled upward. Normally, the detent spring presses the operating lever against a stop. This holds the operating lever in its normal position. The operating lever is also referred to as a handle. It has a handle on the top end of the front limb.

In the case a seat depth adjustment device operated by motor, the electric motor comprises a gearbox connected to a spindle. This is located in the space between the support plate and the base plate. It extends in the sliding direction. It is engaged with a spindle nut, which is connected to the base plate.

### BRIEF DESCRIPTION OF THE DRAWINGS

Further advantages and features of the disclosure arise from the other claims as well as the following description of two exemplary embodiments, which are to be understood as being non-restrictive, shall be explained in more detail with reference to the drawing. The figures in this drawing show the following:

FIG. 1 an exploded view of a manual seat depth adjustment device, wherein a support plate is shown in the half-section with the section line in the sliding direction,

FIG. 2 a perspective illustration of the parts visible from FIG. 1, now in the assembled state,

FIG. 3 a perspective illustration similar to FIG. 2, however, now the support plate is shown in the half-section with the section line being perpendicular to the sliding direction,

FIG. 4 a perspective illustration of a view obliquely from the bottom of the support plate, and

FIG. 5 a perspective illustration similar to FIG. 2, however, now for a motorized seat depth adjustment device.

### DETAILED DESCRIPTION OF THE DRAWINGS

A right-handed, orthogonal x, y, z coordinate system is used for the description. The x-axis is in the sliding direction; the positive x-axis points toward the seating surface that is becoming longer. The y-axis is on the plane of the seating surface; the z-axis points perpendicularly upward from the plane of the seating surface. This coordinate system essentially corresponds to the coordinate system commonly used in automotive technology and is identical to this if the x-y plane is parallel to the road level.

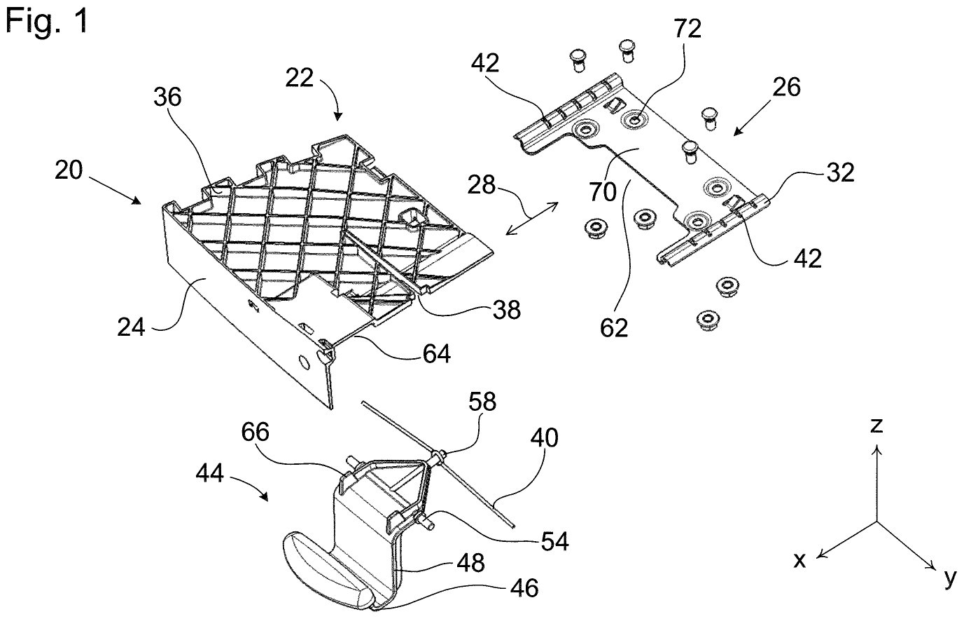

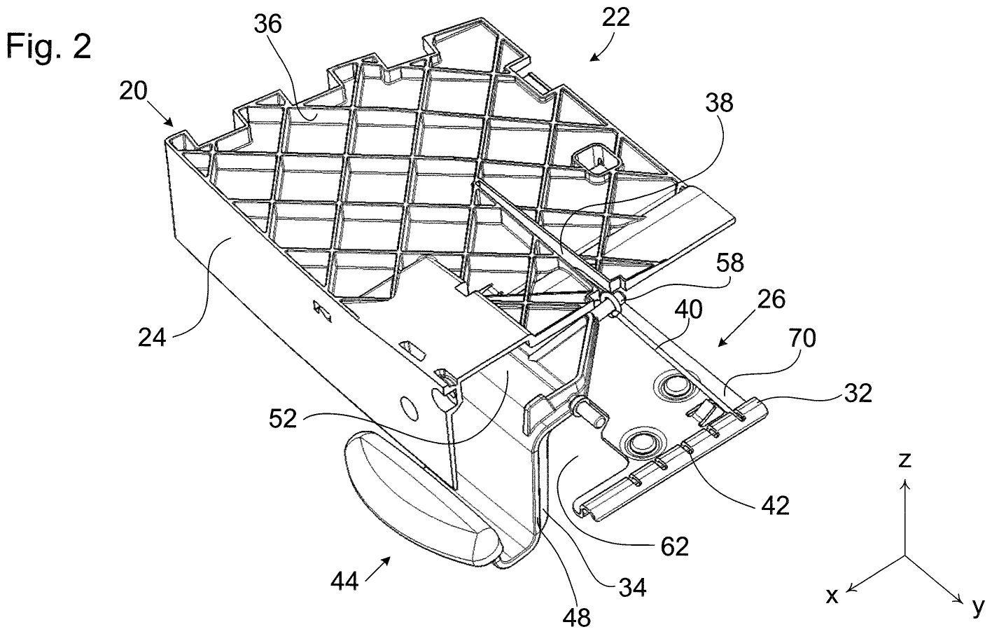

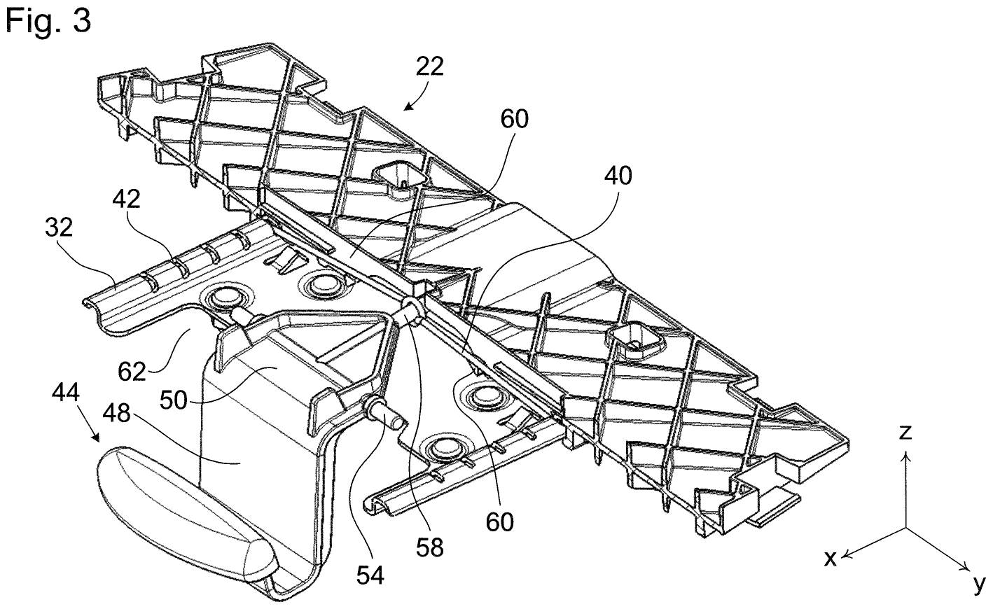

The manual embodiment is shown in FIGS. 1 to 4. The adjustment device has a single-piece support plate 20 made of plastic. This support plate 20 comprises a support part 22 extending in the x-y plane and a front apron 24 attached to its leading edge. The adjustment device furthermore has a base plate 26, which is preferably a single piece and is preferably metallic. The support part 22 has two guides 30 extending parallel to each other in a sliding direction 28 and arranged at a distance from each other. They are arranged at the underside of the support part 22. According to them, the base plate has 26 guide means 32, which, each with one guide 30, form a longitudinal guide. Thus, the support part can only be moved in the sliding direction 28 with relation to the firmly seated plate 26.

The guide means 32 only extend across a part of the length of the two guides 30. Across the entire permissible adjustment path, the guide means 32 always remain within the region of the guides 30 by at least 70%. The sliding path forward, in a positive x-direction, is delimited by the guides 30 leading into the front apron 24.

The front apron 24 essentially extends in the y-z plane; it is slightly bent around an axis parallel to the z-direction. It extends downward from a leading edge of the support part 22. The front apron 24 is reinforced by ribs 34. The support part 22 is striped due to the bars 36 arranged in a square pattern located on its top side. They extend obliquely to the x- and also to the y-axis. They are near the leading edge at least twice as high in the z-direction, as at the rear end of the support part 22.

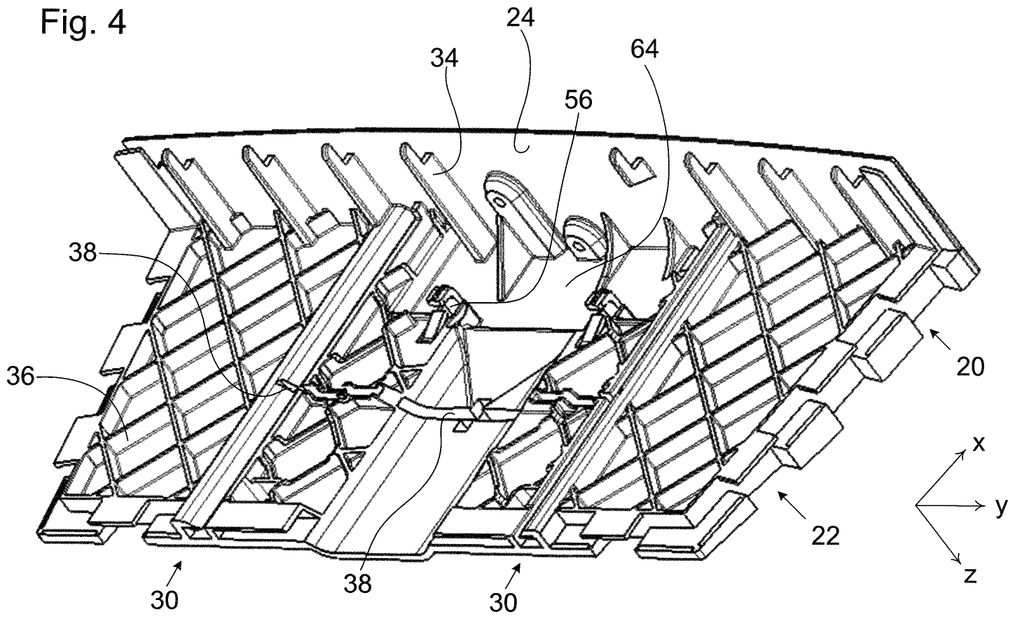

The support part 22 has a slot 38 extending in the direction of the y-axis. It extends from the centre of the support part 22 in both directions of the y-axis to the guides 30 respectively and ends within the guides 30; see FIG. 4. In sliding direction 28, the slot 38 is approximately in the middle of the support part 22. The slot 38 provides space for a detent spring 40, which is only needed for the manual embodiment. It is formed as a double-jointed spring; the limbs start from an annular middle region.

The guide means 32 have open recesses 42 upward in the positive z-direction, which are arranged one following the other in the sliding direction 28. The exemplary embodiment shows five such detent recesses 42. In the normal position, that is, the locking position, a free end of a limb of the detent spring 40 each engages into a detent recess 42. In the process, it is guided in the immediate vicinity of the detent recess 42 in the slot 38, which acts here as a shearing slot. This reduces the load on the limb in the event of an accident or the like.

The manual embodiment has an operating lever 44. It has (i) a U-shaped region with a front limb 46, which is located in front of the front apron 24 and supports a handle on its upper end, a rear limb 48, which is located behind the front apron 24 and a base that connects these two limbs 46, 48 and is located below the lower edge of the front apron 24. It has (ii) a flange 50 which attaches to the upper end of the rear limb 48 and extends toward the back, essentially toward the negative x-axis. This flange 50 is located in a space 52 between support part 22 and base plate 26. This space 52 is only accessible in the sliding direction 28. It has a clear height of a minimum of one to a maximum of 8 cm.

The flange 50 supports a pivot axis 54, which runs in the y-direction. Two end regions are spaced away from it, which are mounted in the bearing regions 56 of the support part 22. They can be clipped into these bearing regions 56 by a movement in the positive x-direction. Furthermore, the flange 50 has a nib 58 protruding in the negative x-direction. It bears down on the annular middle region of the detent spring 40 and takes it with when operating the operating lever 44. This movement is essentially in the z-direction. In its longitudinal centre, the slot 38 has a pocket that takes up the free end of the nib 58.

The support part 22 forms a support 60 within the slot 38 for each limb of the detent spring 40. Each limb lies on a support 60 approximately at its longitudinal centre; it is located above the support 60. The two limbs of the detent spring 40 are at an angle to each other, which is less than 180°, preferably about 150°. As a result, the nib 58 is elastically preloaded in the positive z-direction upward and the flange 50 is attached to the support part 22 so that the normal position of the operating lever 44 is predetermined. The detent spring 40 thus keeps the operating lever 44 elastic in its normal position.

When the operating lever 44 is actuated, whereby the front limb 46 is pulled upward, the nib 58 and thus the annular middle region move downward. The limbs are pressed more strongly onto the support 60. Their free ends move upward. As a result, they are released from the detent recesses 42. An adjustment can be performed.

The base plate 26 has an inlet 62 at its leading edge between the guide means 32. There is a zone of the operating lever 44 in this inlet 62; in particular; the rear limb 48 and the flange 50 are at least partially located there. In the region of inlet 62, there is also a recess 64 of the support part 22. It creates space upward. At their lower surface, projections 66 of the flange 50 come to rest; they delimit the pivot path of the operating lever 44 into the normal position.

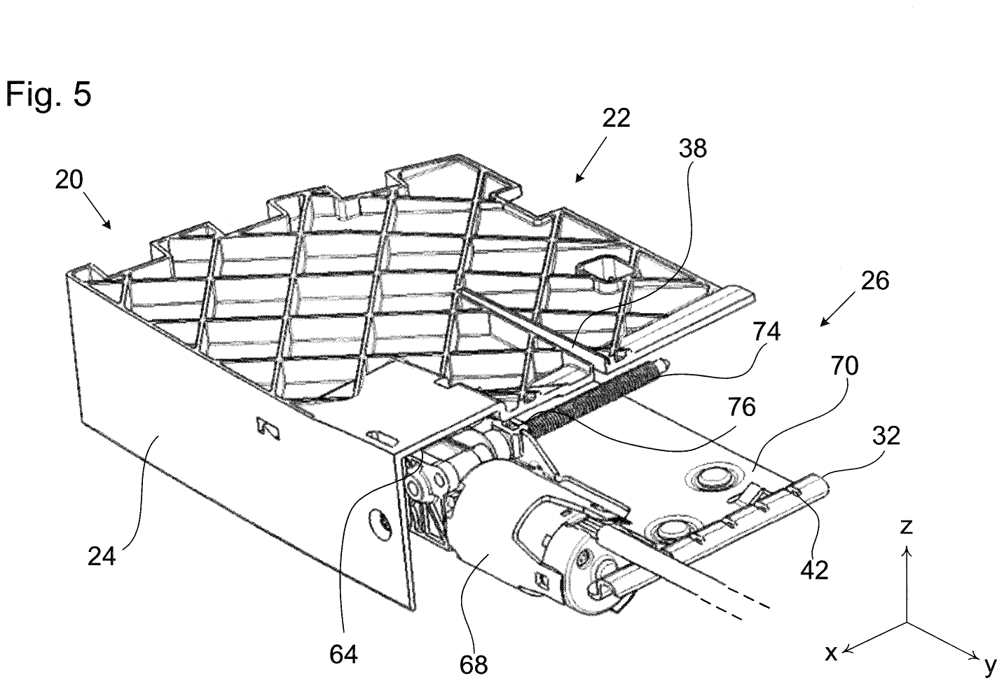

In the motorized embodiment shown in FIG. 5, an electric motor 68 is housed in the accommodating space below the recess 64 and in the region of the inlet 62 and is connected to the support plate 20. The operating lever 44 and detent spring 40 parts are now no longer available, but the other parts are. In other words, the components shown in FIG. 1 in the lower partial figure are not present now, but only the components shown in the two upper partial figures are. The electric motor 68 has a cylindrical motor housing; the cylinder axis extends in the y-direction. It is located approximately at the height of a centre area 70 of the base plate 26. This is essentially flat. Fasteners 72 area provided in it, implemented here with holes, into which screws engage. These fasteners 72 are used to connect to a seating area of a motor vehicle seat (not shown here), both of which are carried out according to the most recent background art. The middle region 70 is lowered down by a few centimetres, for example, 1 to 4 cm compared to the guide means 32, thus, the space 52 is larger than without this lowering.

The electric motor 68 is designed according to the most recent background art. The electric motor 68 is located in the immediate vicinity of the front apron 24. It has a gearbox connected to a spindle 74. This runs in the sliding direction 28. It is located at least partially in the space 52. It is engaged with a spindle nut 76, which is held on a bar part 37 connected to the base plate 26. The spindle 74 is located on the plane where the guide 30 and guide means 32 interlock with one another.

The support plate 20 is essentially symmetrical to the x-z plane. Therefore, in FIG. 1, for example, it is sufficient to show only one half. Likewise, the base plate 26 is symmetrical to the said plane. The operating lever 44 and the detent spring 40 are also symmetrical in this way. The space 52 is preferably also limited by the front apron 24. The seat depth adjustment device for a vehicle seat that can be adjusted in the seat depth thereof electrically by means of an electric motor 68 or manually by means of an operating lever 44, which seat depth adjustment device has a preferably single-piece support plate 20 made of plastic, which comprises a) a support part 22, which extends in the sliding direction 28, b) a front apron 24, c) two guides 30, which extend parallel to each other in the sliding direction 28 and are arranged at a distance from each other and are formed in the support part 22, d) a slot 38 for a detent spring 40, which slot is formed in the support part 22 and extends perpendicularly to the sliding direction 28, and e) a space for the accommodation of at least one part of the operating lever 44 or of the electric motor 68 and for the fastening thereof, which space is open downward and is delimited by the support part 22 and by the front apron 24; and a preferably single-piece, metal base plate 26, which comprises guide means 32 matched to the guides 30, detent recesses 42 arranged one following the other in the sliding direction 28, and fasteners 72 for fastening the base plate to a vehicle seat.

Terms such as ‘substantially’, ‘preferably’ and ‘the like’, as well as possibly inaccurate specifications are to be understood in such a way that a deviation of plus/minus 5%, preferably plus/minus 2% and, in particular, plus/minus one percent from the normal value is possible.

1. A seat depth adjustment device for a vehicle seat configured to be adjusted in an adjustment direction by an electric motor or manually by an operating lever, said seat depth adjustment device comprises:
a single-piece support plate made of plastic, which comprises (a) a support part, which extends in the sliding direction, (b) a front apron, which extends perpendicularly to the sliding direction and points downward from a leading edge of the support part, (c) two guides, which extend parallel to each other in the sliding direction and are arranged at a distance from each other and are formed in the support part, (d) a slot for a detent spring, which slot is formed in the support part and extends perpendicularly to the sliding direction, and (e) a space for the accommodation of at least one part of the operating lever or of the electric motor and for the fastening thereof, which space is open downward and is delimited by the support part and by the front apron, and
a single-piece, metal base plate, which comprises guide means matched to the guides, detent recesses and fasteners arranged one following the other in the sliding direction for the fastening thereof to a motor vehicle seat.

2. The seat depth adjustment device according to claim 1, wherein the guides hit against the front apron moving forward in the sliding direction, being connected to this at the front.

3. The seat depth adjustment device according to claim 1, wherein, on the underside of the support part, two bearing regions are provided for accommodating a pivot axis of the operating lever.

4. The seat depth adjustment device according to claim 1, wherein the guide means are shorter than the guides and, independently of the adjustment position of the support plate with relation to the base plate, the guide means are within the guides by at least over 80% of their length.

5. The seat depth adjustment device according to claim 1, wherein the base plate comprises an inlet at a front end of the base plate, said inlet being located between the guide means and that the electric motor or the operating lever is located in this inlet.

6. The seat depth adjustment device according to claim 1, wherein the support plate comprises two supports arranged in the slot, each of the two supports being disposed between the longitudinal centre of the slot and an end region of the slot.

7. The seat depth adjustment device according to claim 1, wherein the detent recesses are formed in the guides and are upwardly open.

8. The seat depth adjustment device according to claim 1, wherein the slot comprises a pocket between the guides in an indentation of the slot.

9. The seat depth adjustment device with manual actuation and according to claim 1, wherein the detent spring is a two-armed leg spring configured to act with the detent recesses and with the operating lever is elastically preloaded into a normal position.

10. The seat depth adjustment device according to claim 1, wherein the operating lever has a U-shaped region with a front limb located in front of the front apron, with a base located below the front apron and with a rear limb located behind the front apron.

11. The seat depth adjustment device according to claim 10, wherein the operating lever furthermore comprises a flange adjoining the upper end of the rear limb, which is located in the space between the support plate and the base part, which supports the pivot axis, from which two stumps protrude away from the flange on the side and which supports a nib parallel to the sliding direction, which freely extends into the slot and bears down on a middle region of the detent spring.

12. The seat depth adjustment device according to claim 9, wherein the flange comprises cusps that come into contact with the support part, and that this contact limits the pivoting region of the operating lever.

13. The seat depth adjustment device operated by motor and according to claim 1, wherein the electric motor comprises a gearbox connected to a spindle, that the spindle is in the space between the support plate and the base plate and extends in the sliding direction, and that a spindle nut is connected to the base plate and engages with the spindle.

14. The seat depth adjustment device according to claim 13, wherein the electric motor is located in the inlet.
